(19) United States
(12) Patent Application Publication
(10) Pub. No.: US 2020/0094173 A1
(43) Pub. Date: Mar. 26, 2020

(54) A SEPARATION PANEL

(71) Applicant: AQSEPTENCE GROUP PTY LTD, Queensland (AU)

(72) Inventors: Yusuf CAJEE, Queensland (AU); Denys VISSER, Queensland (AU); Grant Christopher ADAMSON, New South Wales (AU)

(73) Assignee: AQSEPTENCE GROUP PTY LTD, Queensland (AU)

(21) Appl. No.: 16/346,399

(22) PCT Filed: Nov. 14, 2017
(86) PCT No.: PCT/AU2017/051243

§ 371 Date: Apr. 30, 2019

(30) Foreign Application Priority Data
Nov. 15, 2016 (AU) 2016904647

(51) Int. Cl. B01D 33/00; B07B 1/46

(52) U.S. Cl. CPC B01D 33/0093; B07B 1/4663; B07B 1/48; B07B 1/469; B07B 1/4672; B07B 1/4618

(57) ABSTRACT

A separation panel includes a body member defining a separation surface and an opposed surface with a plurality of apertures extending through the body member and opening out into the separation surface and the opposed surface of the body member. The body member is made up of a plurality of discrete elements secured together to form substantially hexagonal apertures. A securing arrangement secures the discrete elements together.

### TECHNICAL FIELD

This disclosure relates, generally, to screening and, more particularly, to a separation panel for screening equipment and to screening equipment including a plurality of such separation panels.

### BACKGROUND

In screening/separating applications, the screening equipment used has a reasonably large footprint to facilitate rapid removal of solids or other unwanted material from wastewater or other liquids to be treated. This results in increased costs associated with the necessary infrastructure. It will be appreciated that, if the footprint were able to be reduced, the associated costs of the infrastructure would be able to be correspondingly reduced.

In addition, certain treatment plants have pre-existing infrastructure where conventionally sized band screens are too large to be installed.

Still further, reducing the size of the footprint of the band screen results in a reduction in the associated costs of the band screen itself, due to lower material and labour cost requirements.

### SUMMARY

In some embodiments of the disclosure, there is provided a separation panel which includes a body member defining a separation surface and an opposed surface with a plurality of apertures extending through the body member and opening out into the separation surface and the opposed surface of the body member, the body member being made up of a plurality of discrete elements secured together to form substantially hexagonal apertures and a securing arrangement securing the discrete elements together.

A total open area of the apertures in the separation surface constitutes at least 70% of the separation surface of the body member. The total open area of the apertures in the separation surface may constitute at least 85% of the separation surface of the body member.

In an embodiment, each discrete element may be a corrugated sheet or element having alternating ribs and valleys, adjacent elements being staggered with respect to each other so that a valley of one corrugated element is secured to a rib of a neighbouring corrugated element to form the apertures.

The securing arrangement may comprise welding by means of which the corrugated elements are secured together. The welding may comprise spot welding by means of which at least some mating planar portions of the corrugated elements are secured together by discrete spot welds.

The outermost spot welds may be positioned proximate edges of the corrugated elements.

Each discrete element may be of a suitable corrosion-resistant material, such as a corrosion-resistant metal.

In an embodiment, each discrete element may be in the form of a tube, the tubes being secured together with their longitudinal axes substantially parallel to each other to form the body member.

In a further embodiment, the body member may be an extrusion.

Instead, or in addition, the securing arrangement may comprise bonding by means of which the discrete elements are secured together.

In some embodiments of the disclosure, there is provided screening equipment which includes a support structure; and a screening assembly carried by the support structure, the screening assembly including a plurality of separation panels, as described above, arranged in side-by-side relationship, the separation panels being configured to separate unwanted material from the material to be treated.

In this specification, unless the context clearly indicates otherwise, the term “side-by-side relationship” does not necessarily imply that adjacent separation panels are in a planar relationship relative to each other. Adjacent panels could be arranged at an angle relative to each other.

The support structure may comprise a housing defining an inlet opening through which material to be treated is received in an interior of the housing and an outlet opening via which the unwanted material separated from the material to be treated is removed from the housing, the screening assembly being arranged in the housing.

The screening equipment may include a drive arrangement carried by the support structure, the drive arrangement including a drive unit; and a driven mechanism, driven by the drive unit. In an embodiment, the driven mechanism may arranged on opposed surfaces of the separation panel. In an embodiment, the drive unit may be arranged externally of the screening assembly.

### BRIEF DESCRIPTION OF DRAWINGS

Embodiments of the disclosure are now described by way of example with reference to the accompanying drawings in which:

FIG. 1 shows a perspective view of an embodiment of screening equipment;

FIG. 2 shows, an exploded perspective view of an interior part of the screening equipment of FIG. 1 with only one separation panel shown;

FIG. 3 shows, on an enlarged scale, a perspective view of the drive arrangement of the screening equipment of FIG. 1;

FIG. 4 shows a plan view of a first embodiment of a separation panel for the screening equipment of FIG. 1;

FIG. 5 shows, on an enlarged scale, a plan view of the portion of the panel of FIG. 4 encircled by circle ‘A’ in FIG. 4 of the drawings;

FIG. 6 shows a side view of the first embodiment of the separation panel;

FIG. 7 shows a perspective view of the first embodiment of the separation panel;

FIG. 8 shows, on an enlarged scale, a perspective view of the portion of the panel of FIG. 7 encircled by circle ‘B’ in FIG. 7 of the drawings;

FIG. 9 shows a fragmentary, perspective view of a second embodiment of a separation panel for the screening equipment of FIG. 1;

FIG. 10 shows a fragmentary, plan view of the separation panel of FIG. 9;

FIG. 11 shows a perspective view of a third embodiment of a separation panel for the screening equipment of FIG. 1;

FIG. 12 shows, on an enlarged scale, a perspective view of the portion of the panel of FIG. 11 encircled by circle ‘C’ in FIG. 11 of the drawings;

FIG. 13 shows a fragmentary, perspective view of a fourth embodiment of a separation panel for the screening equipment of FIG. 1;

FIG. 14 shows a fragmentary, plan view of the separation panel of FIG. 13;

FIG. 15 shows a fragmentary, perspective view of a fifth embodiment of a separation panel for the screening equipment of FIG. 1; and

FIG. 16 shows a fragmentary, plan view of the separation panel of FIG. 15.

### DETAILED DESCRIPTION OF EXEMPLARY EMBODIMENTS

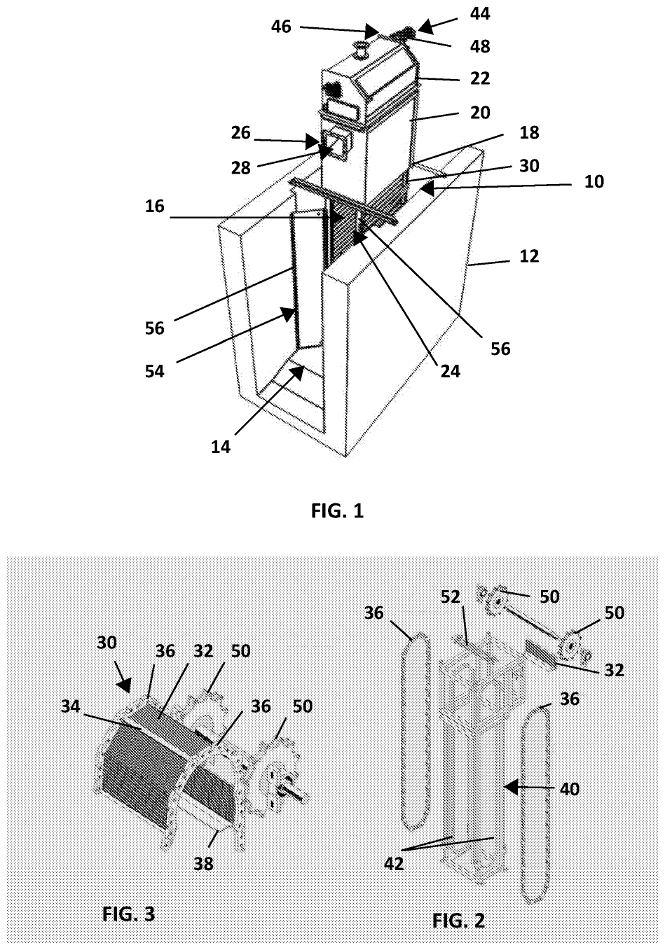

In FIG. 1 of the drawings, reference numeral 10 generally designates an embodiment of screening equipment. While the separation panels referred to below can be used with any suitable screening equipment, one particular application of the screening panels is in band screens, more particularly, dynamic band screens. A dynamic band screen is one having a moving band. For ease of reference only, the separation panels will be described with reference to their use in screening equipment in the form of a band screen. The band screen 10 is, in use, mounted in a structure 12 defining a flow channel 14 by means of which wastewater to be treated is directed into an interior 16 of the band screen 10.

The band screen 10 includes a housing 18 having a lower portion 20 and an upper portion 22. The lower portion defines an inlet opening 24 to provide access for the wastewater to the interior 16 of the band screen 10. An outlet flue 26 is arranged proximate an operatively upper end of the lower portion 20 of the housing 18. The flue defines an outlet opening 28 through which unwanted, or waste, material, separated from the wastewater, is discharged from the band screen 10.

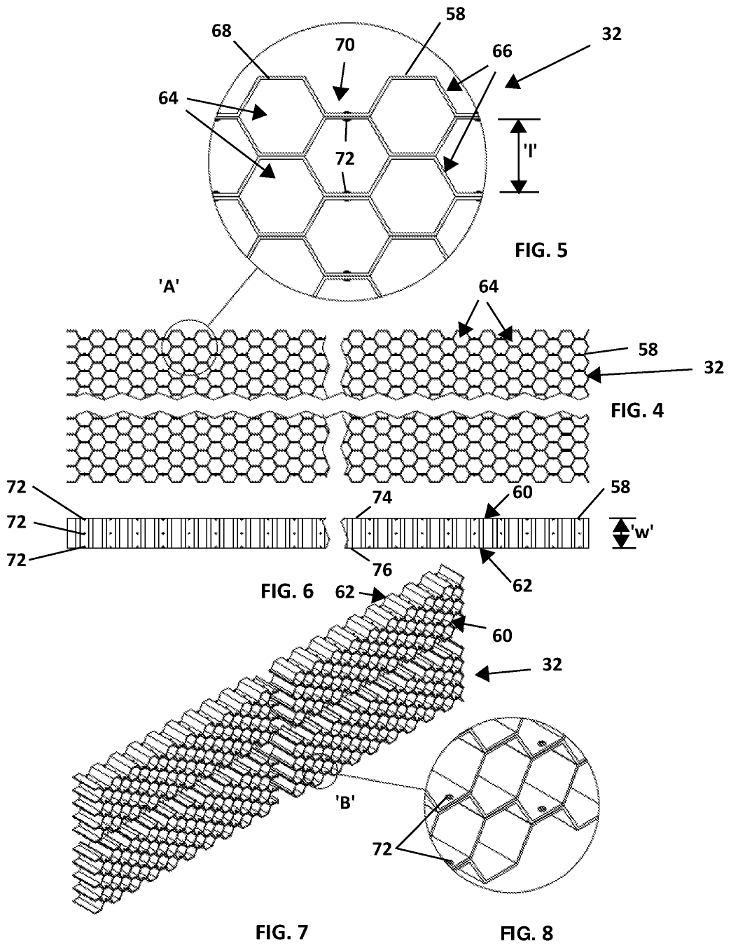

The interior 16 of the housing 18 contains a screening assembly 30, part of which is shown in greater detail in FIG. 3 of the drawings. The screening assembly 30 comprises a plurality of separation panels 32, the structure of which will be described in greater detail below with reference to FIGS. 4-16 of the drawings. The screening assembly 30 includes a plurality of spacer bars 34 (FIG. 3) which separate and support a driven arrangement in the form of a pair of driven chains 36. As shown in FIG. 2 of the drawings, the chains 36 form endless bands. In this specification, unless the context clearly indicates otherwise, the term “chain” is to be understood as meaning a flexible length of links.

Each spacer bar 34 also supports a lifter 38. Each spacer bar 34/lifter 38 defines a groove (not shown) within which an edge of one of the separation panels 32 is received to retain the separation panels 32 in position.

As shown more clearly in FIG. 2 of the drawings, the housing 18 of the band screen 10 comprises a framework 40 supporting the various components of the band screen 10. Those components include a pair of spaced guide tracks 42, each guide track 42 supporting and guiding one of the chains 36 of the driven mechanism of the band screen 10.

The band screen 10 includes a drive unit 44 (FIG. 1) mounted to the upper portion 22 of the housing 18. The driven chains 36, being the driven mechanism of the band screen 10, and the drive unit 44 together form a drive arrangement 46 of the band screen 10. The drive unit 44 comprises an electric motor 48. The motor 48 rotatably drives a pair of spaced gears 50. Each gear 50 engages one of the chains 36 of the driven mechanism of the band screen 10.

In the illustrated embodiment, the driven chains 36 are arranged on outer surfaces, the opposed surfaces, of the separation panels 32. In other embodiments, the driven chain 36 can be arranged between facing ends of the separation panels 32 while, in other embodiments, the driven chain/s 36 could be arranged on operatively inner surfaces, the separation surfaces, of the separation panels 32.

The upper portion 22 of the housing 18 also supports a spray header 52 (FIG. 2). The spray header 52 is provided for cleaning the separation panels 32 of the band screen 10. More particularly, the spray header 52 clears the waste material congregated on a separation surface of each of the separation panels 32 as the separation panels 32 approach their apogee of rotation about the guide tracks 42.

An upstream end of the housing 18 supports a channelling mechanism 54 to channel wastewater towards the inlet opening 24 of the housing 18. The channelling mechanism comprises a pair of spaced channelling panels 56, the panels 56 being angled towards the inlet opening 24 and being arranged on opposed sides of the inlet opening 24 of the housing 18.

Referring now to FIGS. 4-8 of the drawings, a first embodiment of a separation panel 32 is illustrated and is described in greater detail. The separation panels 32 includes a body member 58 defining a separation surface 60 and an opposed, cleaning surface 62. It will be appreciated that, in use, cleaning liquid from the spray header 52 impinges on the separation surface 60 of the body member 58 to clean the separation surface 60 of the body member 58 of the separation panel 32. The body member 32 defines a plurality of apertures 64 extending through the body member and opening out into the separation surface 60 and the opposed, cleaning surface 62 of the body member. Cleaning liquid from the spray header 52 passes through the apertures 64 to clear the apertures of detritus.

In the embodiment illustrated in FIGS. 4-8 of the drawings, the body member is made up of a plurality of discrete elements, in the form of corrugated sheets 66, of a suitable material. In an embodiment, the material is a corrosion-resistance metal such as a suitable stainless steel. An example of suitable stainless steel is 304 stainless steel. Other grades of stainless steel such as, for example, 316L, may be used if required. In addition, suitable chromium steel alloys may also be used.

As a result of the shape of the corrugated sheets 66, the apertures 64 of the separation panels 32 are substantially polygonal in shape, more particularly, hexagonal in shape to provide the greatest possible open area. Each aperture may have a major dimension ‘l’, measured between flats, which is in a range of about 0.5 mm to 10 mm, preferably of the order of about 5 mm and, more particularly, about 4.8 mm. Other ranges include about 0.5 mm to about 2 mm, about 2 mm to about 4 mm, about 4 mm to about 6 mm, about 6 mm to about 8 mm and about 8 mm to about 10 mm.

In an embodiment, each corrugated sheet 66 has a thickness of less than 0.5 mm, preferably in a range of about 0.1 mm to 0.3 mm and, optimally, about 0.2 mm. The selected thickness depends on the application of the separation panel 32. Each corrugated sheet 66 may have a width ‘w’ (FIG. 6) which is approximately double the ‘l’ dimension with about a ±40% tolerance. Thus, in the embodiment where the aperture has a major dimension, ‘l’, of about 4.8 mm, the corrugated sheet 66 has a width dimension, ‘w’, of approximately 10 mm. Once again, the desired width ‘w’ is selected based on the application of the separation panels 32. It will further be appreciated that the width ‘w’ represents the height of the separation panel 32 between the surfaces 60 and 62 of the separation panel 32.

With corrugated sheets 66 of a thickness of approximately 0.2 mm, the separation panel 32, so formed, has an open area exceeding that of the open area of a conventional, plastics panel, such as a polypropylene or polyethylene panel, by a factor approaching 40% to 50%. Typically, a plastics panel has an open area of the order of 40% to 65%. With a separation panel 32 made from corrugated stainless steel sheets 66 with a thickness of 0.2 mm, the open area of the separation panels 32 is approximately 90%. It will be appreciated that “open area” refers to the area defined by all the apertures 64 in the separation surface 60 of the body member 58 of the separation panel 32.

Each corrugated sheet 66 has alternating ribs 68 and valleys 70 with flat “summits” and “floors”, respectively. Adjacent sheets are staggered with respect to each other so that the “floor” of the valleys 70 of the first sheet are secured to “summits” of the ribs 68 of the adjacent sheet to define the apertures 64.

The adjacent corrugated sheets 66 are secured together by an appropriate securing arrangement. In the embodiment illustrated in FIGS. 4-8 of the drawings, the securing arrangement is welding. More particularly, the relevant ribs 68 and valleys 70 of adjacent sheets are secured together by spot welding, as illustrated at 72. In the illustrated embodiment, each rib 68 and valley 70 are secured together by three spot welds. The two outermost spot welds 72 are spaced from edges 74 and 76 (FIG. 6) of the surfaces 60 and 62, respectively, of the body member 58 of the separation panel 32 by an amount not exceeding approximately 1 mm. This reduces the likelihood pinning of hair, other fibre, or the like, in use. It will be appreciated that, instead of spot welding, other types of welding could be used to secure adjacent corrugated sheets 66 together.

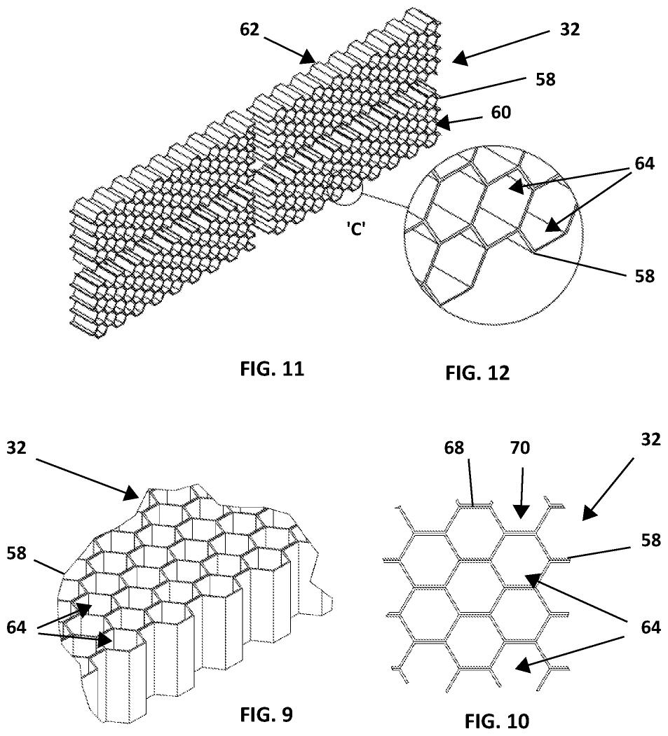

In the embodiment illustrated in FIGS. 9 and 10 of the drawings, where like reference numerals refer to like parts unless otherwise specified, the adjacent corrugated sheets 66 are secured together by a securing arrangement comprising bonding. In other words, outer surfaces of the relevant ribs 68 and valleys 70 of adjacent corrugated sheets 66 are secured together by being adhesively bonded together.

In the embodiment illustrated in FIGS. 11 and 12 of the drawings, an extruded separation panel 32 is illustrated. As in the previous embodiments, like reference numerals refer to like parts unless otherwise specified. In this embodiment, the entire body member 58 of the separation panel 32 is extruded as a one-piece element with substantially hexagonal apertures 64.

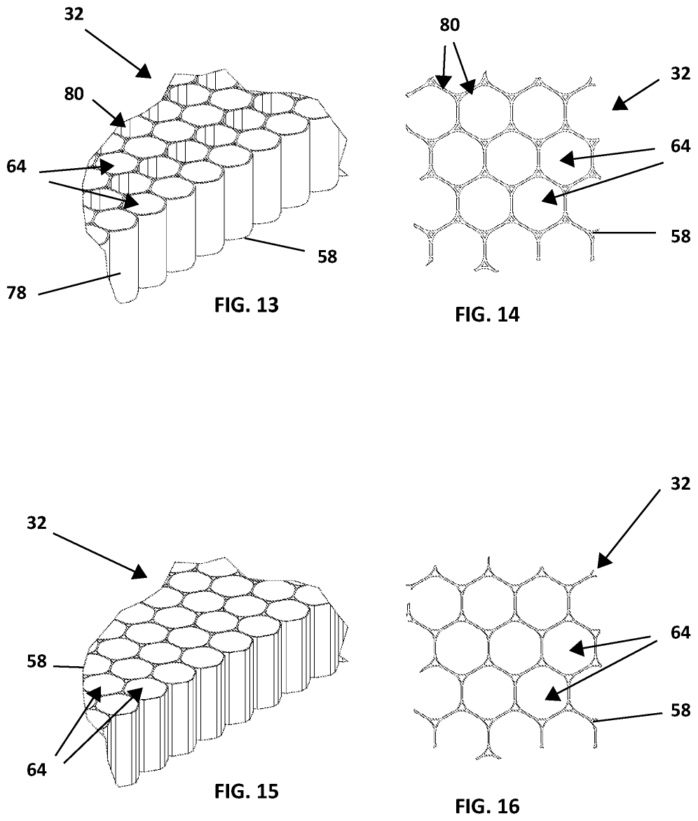

Referring now to FIGS. 13 and 14 of the drawings, a further embodiment of a separation panel 32 is illustrated. Once again, with reference to FIGS. 4-12 of the drawings, like reference numerals refer to like parts unless otherwise specified.

In this embodiment, the body member 58 is constituted by lengths of tube 78 which are secured together with their longitudinal axes extending parallel to one another, the lengths of the tubes defining the width ‘w’ of the body member 58 of the separation panel 32. The lengths of tube 78 are individually formed and then secured together by being fused along neighbouring walls as shown schematically at 80 in FIG. 13 of the drawings.

Generally, in this embodiment the material from which the panel 32 is made is a synthetic plastics material having the requisite crush strength and/or impact resistance.

Referring finally to FIGS. 15 and 16 of the drawings, a further embodiment of a separation panel is shown. Once again, with reference to the preceding embodiments, like reference numerals refer to like parts unless otherwise specified.

In this embodiment, the body member 58 is formed as a single extrusion of a suitable extrudable material such as a suitable metal material or synthetic plastics material.

It will be appreciated that, in respect of all the embodiments, a separation panel 32 for the band screen may be made up as a composite of a number of panel sections arranged end to end and/or side-by-side (as defined). It will be appreciated that the composite need not be planar but could adopt other shapes, for example, curved, zig-zag (i.e. saw toothed when viewed from an end), or the like.

Also, in respect of all the embodiments, each separation panel 32 has an open area exceeding 70% and, optimally, about 85% to 90% of the surface area of the separation surface 60 of the body member 58 of the separation panel 32. As a result, it is an advantage of the described embodiments that a band screen 10, incorporating the separation panels 32, can have a far smaller footprint than band screens using conventional, polyurethane panels. The smaller footprint means that the supply channel to the band screen 10 can also be smaller resulting in reduced materials and associated costs.

Instead, a band screen using separation panels 32 in accordance with the principles described in this specification could be made to have the same sized footprint as band screens using conventional, plastics panels. However, a band screen using separation panel 32 incorporating the principles disclosed herein will have a far higher throughput capacity resulting in greater wastewater treatment efficiencies.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A separation panel which includes
a body member mountable in a liquid flow path, the body member defining a separation surface and an opposed surface with a plurality of apertures extending through the body member and opening out into the separation surface and the opposed surface of the body member, the body member being made up of a plurality of discrete, rigid elements secured together to form substantially hexagonal apertures; and
a securing arrangement securing the discrete elements together.

2. The separation panel of claim 1 in which a total open area of the apertures in the separation surface constitutes at least 70% of the separation surface of the body member.

3. The separation panel of claim 2 in which the total open area of the apertures in the separation surface constitutes at least 85% of the separation surface of the body member.

4. The separation panel of claim 1 in which each discrete element is a corrugated element having alternating ribs and valleys, adjacent elements being staggered with respect to each other so that a valley of one corrugated element is secured to a rib of a neighbouring corrugated element to form the apertures.

5. The separation panel of claim 1 in which the securing arrangement comprises welding by means of which the corrugated elements are secured together.

6. The separation panel of claim 5 in which the welding comprises spot-welding by means of which at least some mating planar portions of the corrugated elements are secured together.

7. The separation panel of claim 6 in which outermost spot welds are positioned proximate edges of the corrugated elements.

8. The separation panel of claim 1 in which each discrete element is of a suitable corrosion-resistant material.

9. The separation panel of claim 1 in which each discrete element is in the form of a tube, the tubes being secured together with their longitudinal axes substantially parallel to each other to form the body member.

10. The separation panel of claim 1 in which the securing arrangement comprises bonding by means of which the discrete elements are secured together.

12. Screening equipment which includes
a support structure; and
a screening assembly carried by the support structure, the screening assembly including a plurality of separation panels, as claimed in claim 1, arranged in side-by-side relationship, the separation panels being configured to separate unwanted material from material to be treated.

13. The screening equipment of claim 11 in which the support structure comprises a housing defining an inlet opening through which the material to be treated is received in an interior of the housing and an outlet opening via which the unwanted material separated from the material to be treated is removed from the housing, the screening assembly being arranged in the housing.

14. The screening equipment of claim 11 which includes a drive arrangement carried by the support structure, the drive arrangement including a drive unit arranged externally of the screening assembly; and a driven mechanism, driven by the drive unit, the drive arrangement driving the screening assembly relative to the support structure.

15. The screening equipment of claim 13 in which the drive unit is arranged externally of the screening assembly.

16. The screening equipment of claim 13 in which the driven mechanism is arranged on the opposed surfaces of the separation panel.
